(19) United States
(12) Patent Application Publication
(10) Pub. No.: US 2004/0109719 A1
(43) Pub. Date: Jun. 10, 2004

(54) Collapsible pen

(76) Inventor: Ron Del Rosso, Santa Barbara, CA (US)

Correspondence Address: Michael G. Petit, P.O. Box 91929, Santa Barbara, CA, 93190-1929, US

(21) Appl. No.: 10/448,756

(22) Filed: Nov. 14, 2003

Related U.S. Application Data
(63) Continuation-in-part of application No. 10/197,040, filed on Jul. 16, 2002, now abandoned.
(60) Provisional application No. 60/357,611, filed on Feb. 14, 2002.

(51) Int. Cl. B43K 23/02

(52) U.S. Cl. 401/131

(57) ABSTRACT

A collapsible pen including a telescopically extensible barrel and a ballpoint refill cartridge having a ballpoint tip removably attached to the barrel. The pen further includes a ballpoint tip cap that releasably attaches to the refill cartridge. The extensible barrel includes an outer tubular member and at least two and most preferably three inner tubular members concentrically and coaxially mounted with respect to both the outer tubular member and to one another. Each inner tubular member has a smaller outer diameter than the overlying tubular members. The ballpoint tip cap, adapted for attachment to a key chain, is releasably attached to either the outer tubular member of the barrel or to the refill cartridge to cover the ballpoint tip. The pen has a fully extended length and a collapsed (retracted) length. With a barrel consisting of three inner tubular members, and the cap removed, the fully extended length of the pen is greater than twice the collapsed length of the pen.

### REFERENCE TO RELATED APPLICATIONS

The present nonprovisional application is a Continuation of U.S. Provisional Application Serial No. 60/357,611, filed Feb. 14, 2002.

### BACKGROUND OF THE INVENTION

1. Field of the Invention

The present invention relates generally to writing implements, and more particularly to a collapsible/extensible pen.

2. Prior Art

Pens that are collapsible or retractable to some portion of their fully extended length are known in the art. Representative of such pens are U.S. Pat. Nos. 3,174,461 and 3,709,620. Mittersinker et al., in U.S. Pat. No. 6,237,627, discloses an extensible pen having a pen barrel with an expanding middle section. The pen barrel holds a retractable ballpoint pen refill cartridge When the pen is expanded, the writing tip of the refill is extended from a retracted position inside the pen barrel to a writing position, while the barrel becomes full length for comfort when writing. The pen may be collapsed for storage, which simultaneously retracts the writing tip inside the pen barrel. The disclosure includes an embodiment wherein the pen includes a cap that is adapted for attachment to a key chain. Due to the construction of the pen, the fully extended length of the pen is necessarily less than two times its collapsed length.

Katoh, in U.S. Pat. No. 4,601,599, discloses a ball-point pen capable of being easily stored in a pocket or the like when not in actual use, and of being readily adjusted to a stand-by position for writing without the possibility of unexpected projection of the pen point. The ballpoint pen is provided with a telescopic body containing a ballpoint pen refill therein, and is constructed so that the pen point is hidden when the body is collapsed and that the pen point is exposed for writing when the body is extended. The ballpoint pen is further provided with retaining means for holding the body in the collapsed condition. When not in use, the ballpoint pen can be more conveniently stored in a pocket or the like if it is made shorter than prior art ones by collapsing the body. Since the body can securely be held in the collapsed state by the retaining means, the pen point is prevented from being unexpectedly exposed. The pen point can be exposed only by extending the body. In the extended state, the overall length of the pen is as long as the length of conventional, fixed-length prior art ballpoint pens. Again, however, due to the construction of the pen wherein the construction of the barrel has only two sliding members, the fully extended length of the pen is necessarily less than two times the collapsed length of the pen.

It is desirable to provide a pen that is truly compact: that is, a pen that can be collapsed to a length that is less than half of its fully extended length, have a fully extended length that is comfortable for writing and that may be attached to a key chain or necklace or the like when not in use. Most preferably, the collapsed length of the pen should be approximately the length of a key (˜2.25 inches) so that it can be conveniently attached to a key chain, and have a fully extended length of about 5 inches—a length that is comfortable for writing.

### SUMMARY

It is an object of the present invention to provide a collapsible pen that has a fully extended length and a collapsed length and which can be extended to a fully extended length that is greater than twice the collapsed length of the pen.

It is a further object of the invention to provide a collapsible pen meeting the above objective and having attachment means thereon operable for attaching the pen to a key chain.

It is yet a further object of the invention to provide a collapsible pen meeting both of the above-stated objectives and wherein the means for attaching the collapsible pen to a chain also securely covers the ink dispensing tip of the collapsible pen when the pen is not in use.

The above objects of the invention are met by providing a collapsible pen having a fully extended length and a collapsed length wherein said fully extended length is greater than or equal to said collapsed length. The collapsible pen comprises: (a) a tubular telescopically extendable barrel having a leading end and a trailing end; (b) a threaded barrel tip affixed to the leading end of the barrel; (c) a ballpoint pen refill cartridge adapted to be releasably attached to the threaded barrel tip; (d) a rear cap affixed to the trailing end of the barrel; and (e) a ballpoint refill cap having a leading end with chain attachment means thereon and a trailing end having a conical cavity therewithin and pen engagement means disposed within the conical recess. The barrel of the collapsible pen barrel comprises an outer tube having an axial bore and at least two axially concentric tubes coaxially and slidably disposed within the axial bore of the outer tube. The two axially concentric tubes comprise a first inner tube having a first axial bore and a second inner tube slidably and coaxially disposed within the first axial bore. The second inner tube preferably has a second axial bore. The threaded barrel tip affixed to the leading end of the outer tube comprising the barrel has a conical outer surface with a first annular groove thereon. The conical recess in the trailing end of the ballpoint refill cap has a second annular groove on an inner surface thereof and a compressible ring disposed within said second annular groove. The combination of the ring and grooves provides means for releasably but securely attaching the barrel to the cap. The cap includes means on the leading end thereof operable for attaching the cap to a chain or the like.

The features of the invention believed to be novel are set forth with particularity in the appended claims. However the invention itself, both as to organization and method of operation, together with further objects and advantages thereof may be best understood by reference to the following description taken in conjunction with the accompanying drawings in which:

### BRIEF DESCRIPTION OF THE DRAWINGS

FIG. 1 is a partially exploded perspective view of a collapsible pen in accordance with the present invention with the pen in a collapsed position.

FIG. 2 is a side, partially cross-sectional view of the collapsible pen of FIG. 1 in a fully extended position.

FIG. 3 is a partially cross-sectional view of the ballpoint tip of the pen of FIGS. 1 and 2 showing the relationship between the ballpoint refill and the outer tubular member comprising the barrel.

FIG. 4 is a perspective view of a cap adapted for releasable attachment to the ballpoint refill or the outer tubular member of the pen and to a key chain.

FIG. 5 is a perspective view of the collapsible pen in accordance with the present invention with the cap attached to a key chain and the pen in a fully collapsed configuration.

FIG. 6 is a side elevational view of a ballpoint tip cap adapted to be attached to a ring or chain in accordance with a preferred embodiment of the present invention.

FIG. 7 is a longitudinal cross-sectional view of the preferred embodiment of the ballpoint tip cap of FIG. 6.

FIG. 8 is a partially cross-sectional view of the writing tip of a pen in accordance with a preferred embodiment of the present invention wherein the refill cartridge has an annular groove thereon adapted to matingly and releasably engage the ballpoint tip cap of FIGS. 6 and 7.

### DESCRIPTION OF THE PREFERRED EMBODIMENTS

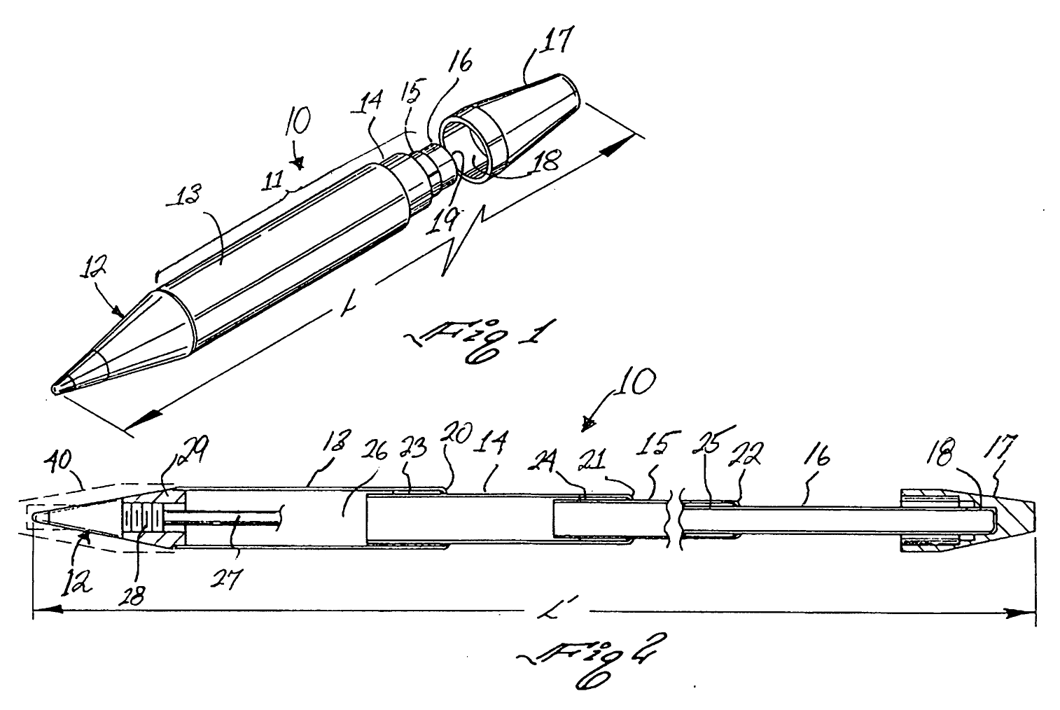

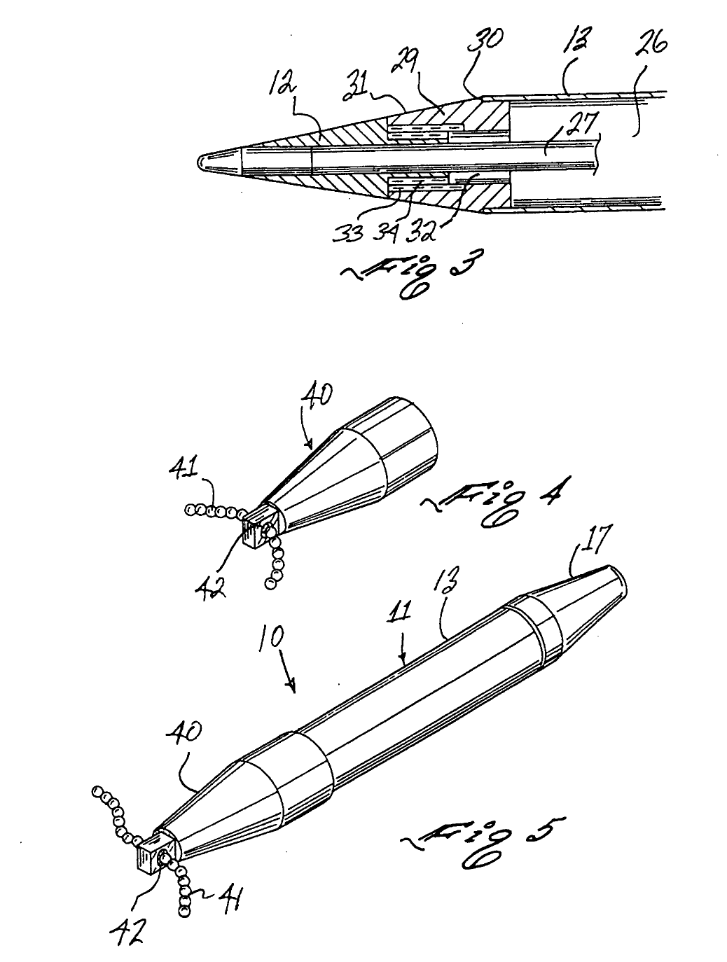

With reference to FIG. 1, a collapsible pen 10 in accordance with a first embodiment of the present invention is illustrated in perspective view. The pen 10 comprises a barrel 11 and a ballpoint refill 12 removably attached to the barrel 11. The barrel 11 comprises three or more concentric tubular members. The first embodiment of the pen 10 illustrated in FIGS. 1 and 2 has a barrel 11 comprising four tubular members. An outer tubular member 13 overlies coaxially disposed inner tubular members 14, 15 and 16 respectively. A rear cap 17 has a recess 18 therein, the rearmost portion of the recess 18 adapted to matingly and nonreleasably engage the trailing end 19 of inner tubular member 16.

Turning now to FIG. 2, the pen 10 is illustrated in partially cross-sectional side view in a fully extended configuration. The trailing end 20 of outer tubular member 13 is recurved inwardly as is the trailing ends 21 and 22 of inner tubular members 14 and 15 respectively. The leading ends 23, 24 and 25 of inner tubular members 14, 15 and 16 respectively are expanded at their respective outer diameters to prevent retraction of the respective inner tubular members from within the axial bore 26 of an overlying tubular member. The ballpoint refill 12 has a trailing end comprising an ink reservoir 27 that is housed within the axial bore 26 of the barrel 11. The ballpoint refill 12 has a threaded portion 28 adapted to matingly engage a threaded barrel tip 29 affixed to the leading end of the outer tubular member 13. The cylindrical recess 18 in the rear cap 17 is constricted in the rearmost portion thereof to friction fit over the trailing end of the innermost inner tubular member 16. The cylindrical bore comprising the forward end of the cylindrical recess 18 in the rear cap 17 has a diameter greater than or equal to the outer diameter of the outer tubular member 13.

FIG. 3 is a detailed partially cross-sectional view of the ballpoint refill tip attached to the leading end 30 of the outer tubular member 13 by means of a threaded barrel tip 29 that is friction fit within the leading end of the axial bore 26 of the outer tubular member 13. The threaded barrel tip 29 enables the ballpoint refill 12 to be removed and replaced when the ink reservoir 27 is empty. The threaded barrel tip 29 has a conical outer surface 31 and an axial bore 32 dimensioned to enable the ink reservoir 27 to pass therethrough into the axial bore 26 of the outer tubular member. A threaded portion 33 of axial bore 32 is threaded to engage threads 34 on the ballpoint refill 12.

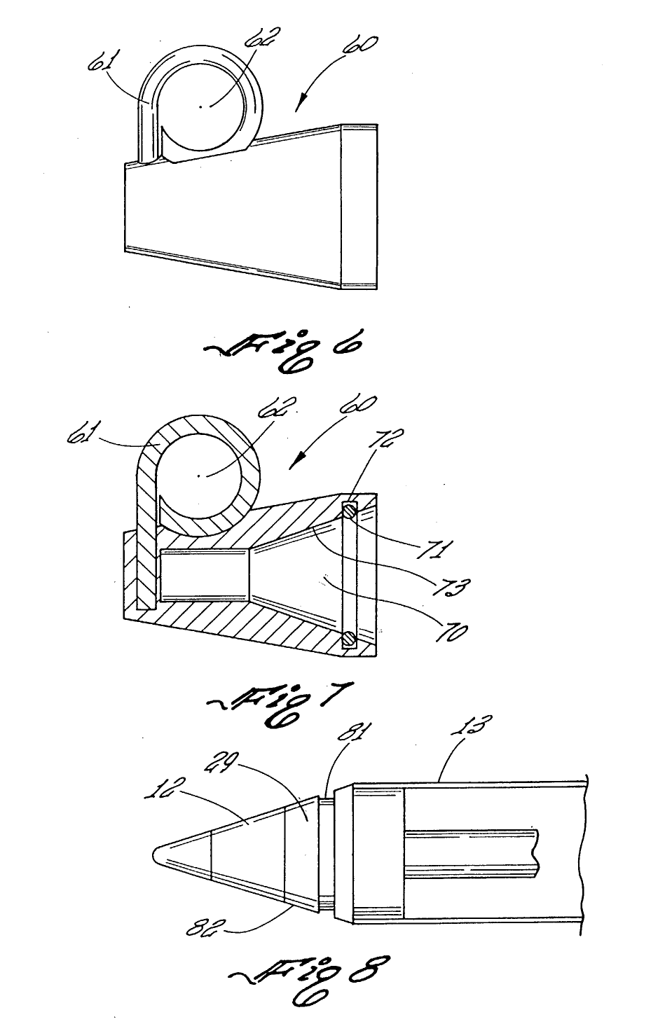

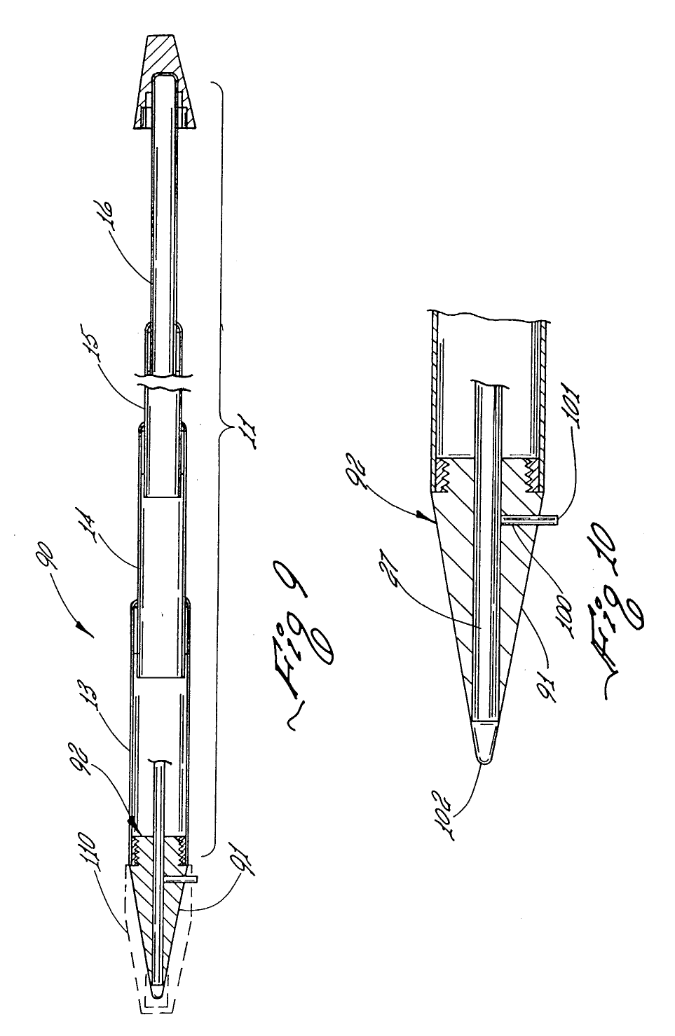

The collapsible pen 10 further preferably includes a removable cap 40, a first embodiment of which is shown in perspective view in FIG. 4. The first embodiment of the cap 40 has an inner recess with pen engagement means thereon (not visible in FIG. 4) operable for releasably engaging mating cap engagement means disposed on the outer surface of either the outer tubular member 13, or most preferably, the ballpoint refill 12 or the threaded barrel tip 29 of the collapsible pen 10. A fully assembled collapsible pen 10 attached to a key chain 41 by means of a hole 42 in the cap 40 is shown in perspective view in FIG. 5. Typical dimensions for a collapsible pen having an outer tubular member and three inner tubular members is collapsed length L=2.25″, and the fully extended length L′=4.75″. Thus the extended length L′ of the pen 10 is greater than twice the collapsed length L′ of the pen.

FIG. 6 is a side elevational view of a preferred embodiment of a ballpoint tip cap 60 in accordance with the present invention that is adapted to be attached to a key ring or chain as shown at 41 in FIGS. 4 and 5. The cap 60 includes chain attachment means 61 having an aperture 62 therein dimensioned to accommodate a chain or ring passed therethrough. The chain attachment means 61 extends laterally from the cap 60 to reduce the overall length of the collapsible pen 10.

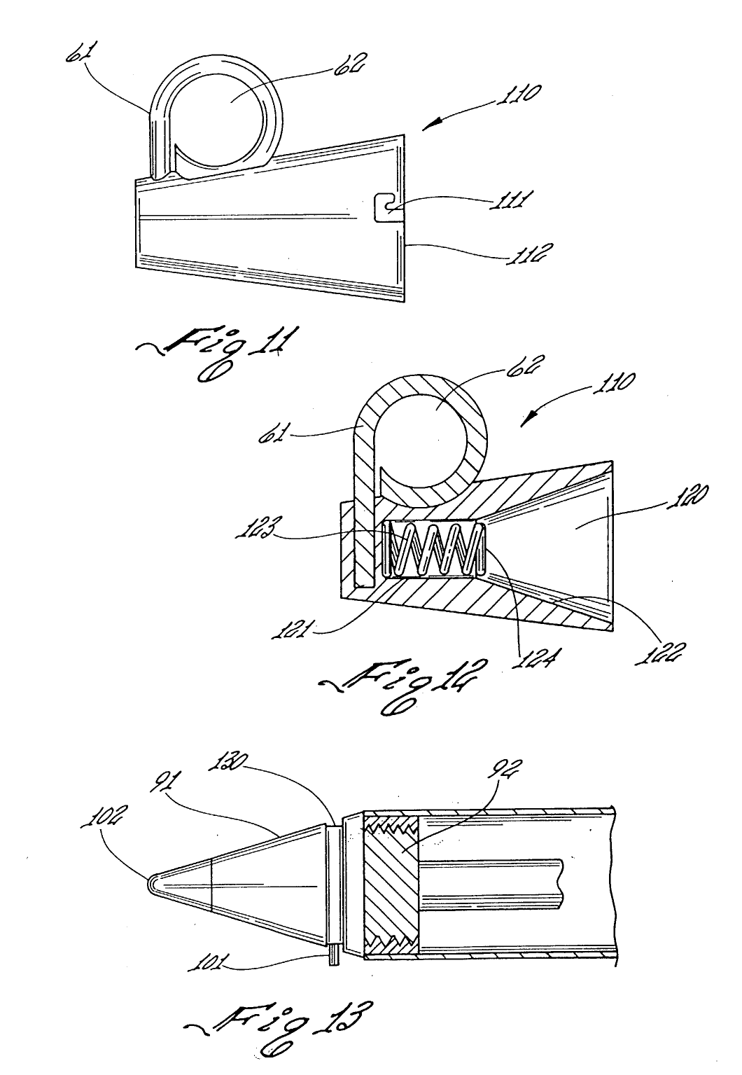

FIG. 7 is a longitudinal cross-sectional view of the preferred embodiment of the ballpoint tip cap 60 of FIG. 6. The cap 60 has a recess 70 with a conical inner surface 73 tapered to mate with the contour of the outer surface of the conical tip of the threaded barrel tip 29 and/or the ballpoint refill 12. The inner surface 73 of the conical recess 70 has an annular groove 72 circumscribed therein that houses a split, substantially circular, elastically extensible and/or compressible ring 71. The outer perimeter of the ring 71 is elastically extensible outwardly (i.e., deeper into the annular groove 72) when a radial, outwardly directed force is applied to the inner circumference of the ring 71. The ring 71 and groove 72 provide the cap 60 with pen releasable engagement means as will be discussed below.

FIG. 8 is a partially cross-sectional view of the writing tip of a collapsible pen in accordance with a preferred embodiment of the present invention wherein either the threaded barrel tip 29 or the refill cartridge 12 has an annular groove 81 circumscribed thereon to matingly and releasably engage the elastically compressible ring 71 comprising the pen engagement means of the ballpoint cap 60 of FIGS. 6 and 7. When the conical ink-dispensing tip of the ballpoint refill 12 is inserted forcefully into the conical recess 70 within the cap 60, the conical outer surface 82 of the threaded barrel tip 29 (or the ballpoint refill) urges the ring 71 radially outward, deeper into the groove 72. Further advancement of the threaded barrel tip 29 into the recess 70 causes the ring 71 to expand into the annular groove 81 thereby releasably engaging the cap 60 to the threaded barrel tip 29. Subsequent retraction of the pen barrel 13 will compress the ring 71, forcing it into groove 72 and release the pen barrel from the cap. The ring 71 may be a compressible “O-ring” or, more preferably, a “C-ring” made from plastic or a, elastically deformable metal that is softer than the material comprising the conical outer surface of the threaded barrel tip 29 or the ballpoint refill 12.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What I claim is:

1. A collapsible pen having a fully extended length and a collapsed length wherein said fully extended length is greater than or equal to said collapsed length.

2. The collapsible pen of claim 1 wherein said collapsible pen comprises: (a) a tubular telescopically extendable barrel having a leading end and a trailing end; (b) a threaded barrel tip affixed to said leading end of said barrel; (c) a ballpoint pen refill cartridge adapted to be releasably attached to said threaded barrel tip; (d) a rear cap affixed to said trailing end of said barrel; and (e) a ballpoint refill cap having a leading end with chain attachment means thereon and a trailing end having a conical cavity therewithin and pen engagement means disposed within said conical recess.

3. The collapsible pen in accordance with claim 2 wherein said barrel comprises an outer tube having an axial bore and at least two axially concentric tubes coaxially and slidably disposed within said axial bore of said outer tube.

4. The collapsible pen of claim 3 wherein said at least two axially concentric tubes comprise a first inner tube having a first axial bore and a second inner tube slidably and coaxially disposed within said first axial bore.

5. The collapsible pen of claim 4, wherein said second inner tube has a second axial bore.

6. The collapsible pen of claim 1 wherein said threaded barrel tip has a conical outer surface with a first annular groove thereon.

7. The collapsible pen of claim 6 wherein said conical recess in said ballpoint refill cap has a second annular groove on an inner surface thereof and a compressible ring disposed within said second annular groove.

8. The collapsible pen of claim 7 wherein said collapsed length is between 2 and 2.5 inches and said extended length is between 4 and 6 inches.
